(19) United States
(12) Patent Application Publication
(10) Pub. No.: US 2015/0066575 A1
(43) Pub. Date: Mar. 5, 2015

(54) ENTERPRISE RISK ASSESSMENT

(71) Applicant: Bank of America Corporation, Charlotte, NC (US)

(72) Inventors: Igor A. Baikalov, Thousand Oaks, CA (US); Brian F. McHugh, Charlotte, NC (US)

(73) Assignee: Bank of America Corporation, Charlotte, NC (US)

(21) Appl. No.: 14/012,918

(22) Filed: Aug. 28, 2013

(51) Int. Cl. G06Q 10/06

(52) U.S. Cl. CPC G06Q 10/0635
USPC 705/7.28

(57) ABSTRACT

Methods and apparatus are disclosed for assessing risk in an enterprise. A server may receive risk scores indicating an asset's risk level across various risk vectors. The server may aggregate the risk scores and assess score ranges for each risk vector. For each risk vector, the server may then segregate the risk scores based on their rank amongst the other risk scores within the range (e.g., top 10%, bottom 60%, and the like). Next, the server may apply a grading rubric to assign grades for each percentage (e.g., top 10% is an F grade, bottom 60% is an A grade and the like) assign grade points (e.g., an F grade is a 0.0, an A grade is a 4.0, and the like). By calculating a grade point average, the server may be able to provide a uniform system of assessing and evaluating risk across all assets in the enterprise.

### TECHNICAL FIELD

Aspects of the disclosure relate generally to assessing risk across an enterprise. In particular, various aspects of the disclosure relate to methods and apparatuses for assigning a uniform risk scoring system for assets in an enterprise.

### BACKGROUND

Large enterprises routinely collect vast amounts of risk data across various types of assets, such as systems, users, applications, and databases. While each of the monitoring or assessment tools may provide consistent risk scores for the corresponding risk vector, comparing and aggregating risks across multiple vectors has always been a challenge for effective risk modeling. Therefore, an enterprise's view of its overall risk is obscured and it may be unable to identify areas of high risk.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

Certain aspects disclose a computer-implemented method, comprising: receiving, at a server a first risk score, wherein the first risk score indicates a first asset's level of risk for a particular risk vector; storing the first risk score at the server; comparing, at the server, the first risk score with other risk scores to determine a percentage of the other risk scores that are higher than the first risk score, wherein the other risk scores indicate other assets' level of risk for the particular risk vector; calculating, at the server, a first grade for the first asset's level of risk for the particular risk vector, wherein the first grade is calculated based on the percentage and a predetermined grading rubric; and outputting, at the server, the first grade.

Certain other aspects disclose a non-transitory computer-readable storage medium having computer-executable program instructions stored thereon that, when executed by a processor, cause the processor to: receive, at a server, a plurality of risk scores for a plurality of assets in an enterprise, wherein each asset is associated with each risk score indicating the asset's level for a particular risk vector; for each risk vector, comparing, at the server, each risk score to determine a percentage of the plurality of risk scores that are higher than each risk score; calculating, at the server, a grade for the each asset's level of risk for the particular risk vector, wherein the first grade is calculated based on the percentage and a predetermined grading rubric; and outputting, at the server, the grade.

Certain other aspects disclose an apparatus comprising: a memory; a processor, wherein the processor executes computer-executable program instructions which cause the processor to: receive a plurality of risk scores for a plurality of assets in an enterprise, wherein each asset is associated with each risk score indicating the asset's level for a particular risk vector; for each risk vector, compare each risk score to determine a percentage of the plurality of risk scores that are higher than each risk score; calculate a grade for the each asset's level of risk for the particular risk vector, wherein the first grade is calculated based on the percentage and a predetermined grading rubric; and output the grade.

The details of these and other embodiments of the disclosure are set forth in the accompanying drawings and description below. Other features and advantages of aspects of the disclosure will be apparent from the description, drawings, and claims.

### BRIEF DESCRIPTION OF THE DRAWINGS

All descriptions are exemplary and explanatory only and are not intended to restrict the disclosure, as claimed. The accompanying drawings, which are incorporated in and constitute a part of this specification, illustrate embodiments of the disclosure and, together with the description, sever to explain principles of the disclosure. In the drawings:

FIG. 1 shows an illustrative operating environment in which various aspects of the disclosure may be implemented.

FIG. 2 shows an illustrative shows an illustrative block diagram of workstations and servers that may be used to implement the processes and function of one or more aspects of the present disclosure.

FIG. 3 shows an illustrative embodiment of a flow chart for calculating risk grades in accordance with aspects of the disclosure.

FIG. 4 shows an illustrative embodiment of a flow chart for risk grade point averages in accordance with aspects of the disclosure.

FIG. 5 shows an illustrative embodiment of grading rubrics in accordance with aspects of the disclosure.

### DETAILED DESCRIPTION

In accordance with various aspects of the disclosure, methods, non-transitory computer-readable media, and apparatuses are disclosed for assessing risk across an enterprise. In certain aspects, when a server receives data from a computing device, the server processes and analyzes the data. The automated process may utilize various hardware components (e.g., processors, communication servers, memory devices, and the like) and related computer algorithms to generate image data related to the agency's business data.

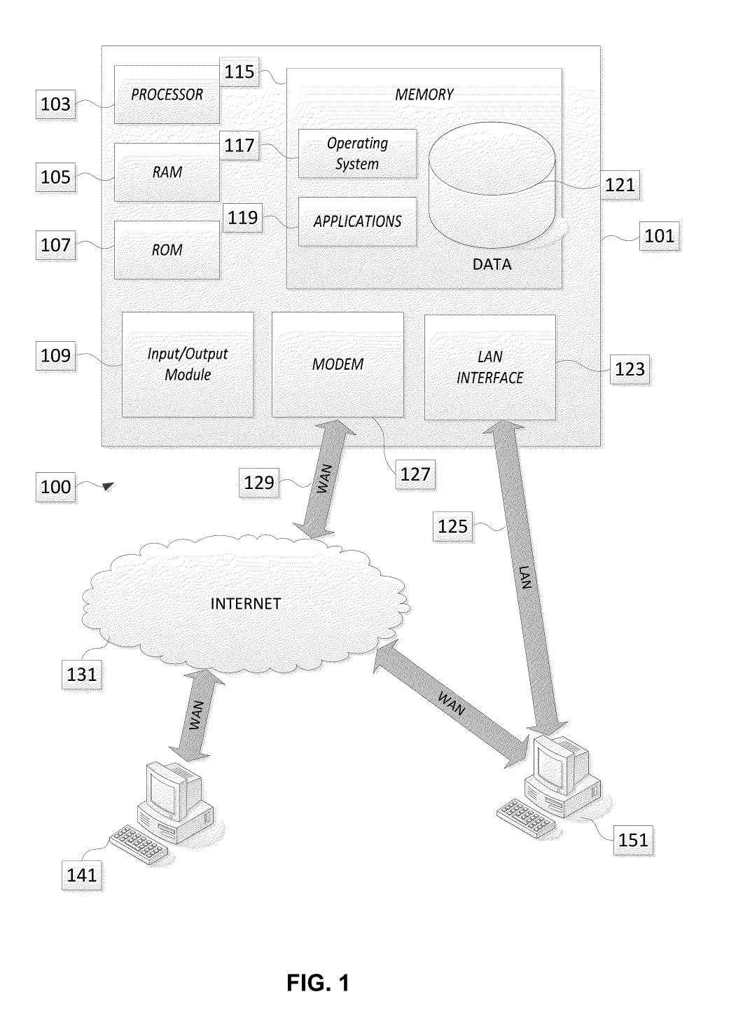

FIG. 1 illustrates an example of a suitable computing system environment 100 that may be used according to one or more illustrative embodiments. The computing system environment 100 is only one example of a suitable computing environment and is not intended to suggest any limitation as to the scope of use or functionality contained in the disclosure. The computing system environment 100 should not be interpreted as having any dependency or requirement relating to any one or combination of components shown in the illustrative computing system environment 100.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, multiprocessor systems, microprocessor-based systems, set-top boxes, programmable consumer electronics, network PCs, minicomputers, mainframe computers, distributed computing environments that include any of the above systems or devices, and the like.

With reference to FIG. 1, the computing system environment 100 may include a server 101 wherein the processes discussed herein may be implemented. The server 101 may have a processor 103 for controlling the overall operation of the server 101 and its associated components, including random-access memory (RAM) 105, read-only memory (ROM) 107, communications module 109, and memory 115. Processor 103 and its associated components may allow the server 101 to run a series of computer-readable instructions related to receiving, storing, and analyzing data to determine an event's risk level.

Server 101 typically includes a variety of computer-readable media. Computer-readable media may be any available media that may be accessed by server 101 and include both volatile and non-volatile media, removable and non-removable media. For example, computer-readable media may comprise a combination of computer storage media and communication media.

Computer storage media include volatile and non-volatile, removable and non-removable media implemented in any method or technology for storage of information such as computer-readable instructions, data structures, program modules, or other data. Computer storage media include, but are not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information that can be accessed by server 101.

Computing system environment 100 may also include optical scanners (not shown). Exemplary usages include scanning and converting paper documents, such as correspondence, data, and the like to digital files.

Although not shown, RAM 105 may include one or more applications representing the application data stored in RAM 105 while the server 101 is on and corresponding software applications (e.g., software tasks) are running on the server 101.

Communications module 109 may include a microphone, keypad, touch screen, and/or stylus through which a user of server 101 may provide input, and may also include one or more of a speaker for providing audio output and a video display device for providing textual, audiovisual and/or graphical output.

Software may be stored within memory 115 and/or storage to provide instructions to processor 103 for enabling server 101 to perform various functions. For example, memory 115 may store software used by the server 101, such as an operating system 117, application programs 119, and an associated database 121. Also, some or all of the computer executable instructions for server 101 may be embodied in hardware or firmware.

Server 101 may operate in a networked environment supporting connections to one or more remote computing devices, such as computing devices 1141, 151, and 161. The computing devices 141, 151, and 161 may be personal computing devices or servers that include many or all of the elements described above relative to the server 101. Computing device 161 may be a mobile device communicating over wireless carrier channel 171.

The network connections depicted in FIG. 1 include a local area network (LAN) 125 and a wide area network (WAN) 129, but may also include other networks. When used in a LAN networking environment, server 101 may be connected to the LAN 125 through a network interface or adapter in the communications module 109. When used in a WAN networking environment, the server 101 may include a modem in the communications module 109 or other means for establishing communications over the WAN 129, such as the Internet 131 or other type of computer network. It will be appreciated that the network connections shown are illustrative and other means of establishing a communications link between the computing devices may be used. Various well-known protocols such as TCP/IP, Ethernet, FTP, HTTP and the like may be used, and the system may be operated in a client-server configuration to permit a user to retrieve web pages from a web-based server. Any of various conventional web browsers may be used to display and manipulate on web pages.

Additionally, one or more application programs 119 used by the server 101, according to an illustrative embodiment, may include computer executable instructions for invoking functionality related to communication including, for example, email short message service (SMS), and voice input and speech recognition applications. In addition, the application programs 119 may include computer executable instructions for invoking user functionality related to access a centralized repository for performing various service tasks like routing, logging, and protocol bridging.

Embodiments of the disclosure may include forms of computer-readable media. Computer-readable media include any available media that can be accessed by a server 101. Computer-readable media may comprise storage media and communication media and in some examples may be non-transitory. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For instance, aspects of the method steps disclosed herein may be executed on a processor 103 on server 101. Such a processor may execute computer-executable instructions stored on a computer-readable medium.

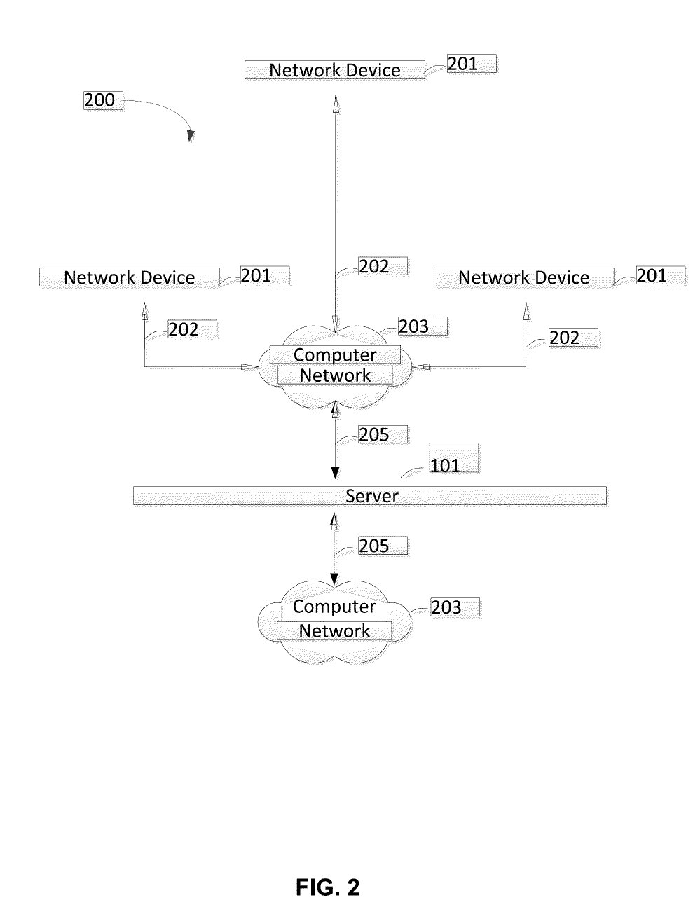

FIG. 2 illustrates another example operating environment in which various aspects of the disclosure may be implemented. As illustrated, system 200 may include one or more workstations 201. Workstations 201 may, in some examples, be connected by one or more communications links 202 to computer network 203 that may be linked via communications links 205 to server 204. In system 200, server 204 may be any suitable server, processor, computer, or data processing device, or combination of the same. Server 204 may be used to process the instructions received from, and the transactions entered into by, one or more participants.

According to one or more aspects, system 200 may be associated with a financial institution, such as a bank. Various elements may be located within the financial institution and/or may be located remotely from the financial institution. For instance, one or more workstations 201 may be located within a branch office of a financial institution. Such workstations may be used, for example, by customer service representatives, other employees, and/or customers of the financial institution in conducting financial transactions via network 203. Additionally or alternatively, one or more workstations 201 may be located at a user location (e.g., a customer's home or office). Such workstations also may be used, for example, by customers of the financial institution in conducting financial transactions via computer network 203.

Computer network 203 may be any suitable computer network including the Internet, an intranet, a wide-area network (WAN), a local-area network (LAN), a wireless network, a digital subscriber line (DSL) network, a frame relay network, and asynchronous transfer mode network, a virtual private network (VPN), or any combination of any of the same. Communications links 202 and 205 may be any communications links suitable for communicating between workstations 201 and server 204, such as network links, dial-up links, wireless links, hard-wired links, and/or the like.

Having described an example of a computing device that can be used in implementing various aspects of the disclosure and an operating environment in which various aspects of the disclosure can be implemented, several embodiments will now be discussed in greater detail.

Aspects of the disclosure may pertain to assessing risk levels across an enterprise (e.g., a corporation, business, company, and the like). Exemplary embodiments of the disclosure may be applied by financial enterprises (e.g., banks). An enterprise typically comprises various assets (e.g., users, applications, systems, and the like). An asset may be considered an entity that performs actions in an enterprise. In an enterprise network (e.g., computer network 203), each asset (e.g., network device 201) may be associated with one or more risk vectors. A risk vector may be considered a categorized segmentation of an asset's potential vulnerabilities in a network. For example, an asset (e.g., a system) may be associated with a plurality of risk vectors (e.g., vulnerability, compliance, malware, and the like). Each risk vector provides an aspect of the system that an enterprise may monitor to assess levels of risk in the network. For instance, the malware risk vector may pertain to the amount of malware detected on the system. Thus, the enterprise may monitor the malware risk vector to the level of risk that the system may be attacked by malware and/or the system will attack other assets in the network with malware.

The enterprise may provide a risk score to indicate an asset's level of risk (e.g., potential to harm other assets in the network, potential to be harmed, and the like). For example, risk scores for the malware risk vector may range from 0-700, with 700 indicating the highest level of risk and 0 indicating the lowest level of risk. Risk scores may be calculated for each asset and for each risk vector. However, risk scores may often be calculated using inconsistent scoring scale across risk vectors. For instance, a system (e.g., the asset) may be associated with a compliance risk vector (e.g., indicating compliance of passwords, detecting if all patches are installed, determining whether the operating system is up to date, and the like) which may comprise a range of risk scores from 0-300 (e.g., 300 indicates the highest risk and 0 indicates the lowest risk). Therefore, risk scores across risk vectors may not provide consistent information of an enterprise's risk levels (e.g., a 90 risk score may indicate a very low level of risk for the malware risk vector whereas a 90 risk score may indicate a higher level of risk for the compliance risk vector). Furthermore, some risk scores may not be calculated on a range of possible risk scores, but may instead comprise a sum total of events counted for the risk vector. For example, an asset (e.g., user) may be associated with an access rates risk vector (e.g., indicates the number of times a user attempts to access resource beyond its level of access). The risk scores for the access rates risk vector for a particular user may simply provide the number of times the user has to access resource beyond its level of access (e.g. a user with a risk score of 7 has a higher level of risk for the access rates risk vector than a user with a risk score of 3). Aspects of the disclosure provide methods and apparatuses for aggregating the risk scores for various assets associated with various risk vectors in an enterprise and may provide a single measure of risk across the enterprise.

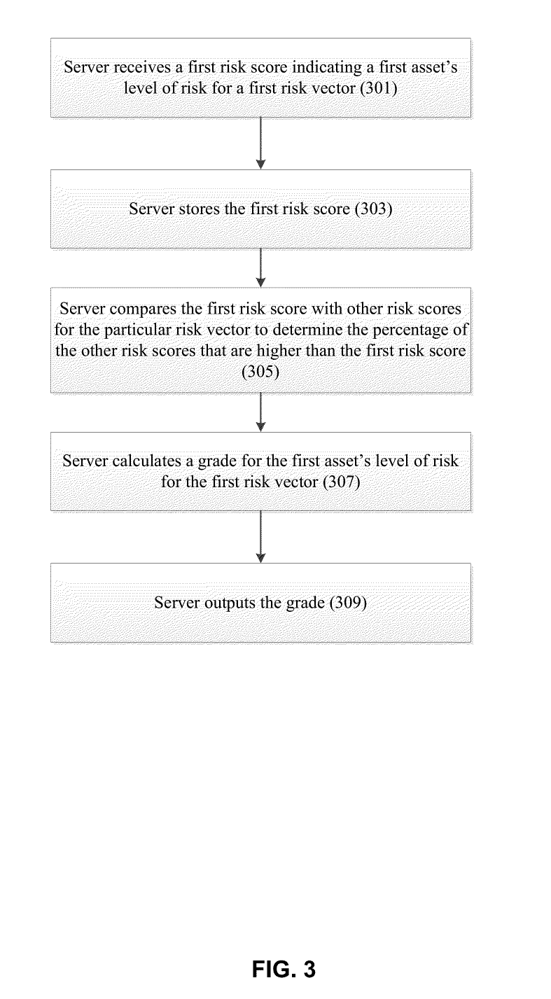

FIG. 3 illustrates an exemplary flow chart according to certain aspects of the disclosure. At step 301, a server (e.g., server 101) may receive a first risk score. The first risk score may indicate a first asset's level of risk for a first risk vector. For example, server 101 may receive a risk score of 170 (e.g., the first risk score), which may indicate a system's (e.g., the first asset) level of risk for a compliance risk vector (e.g., the first risk vector) as described above. Server 101 may receive the first risk score from one or more scanners (e.g., vulnerability scanners, malware scanners, and the like) that scan each asset to detect the level of risk associated with each asset's risk vector. In some aspects, server 101 may itself scan assets to determine their associated risk levels.

After server 101 receives the first risk score at step 301, server 101 may store the first risk score at step 303. Server 101 may store the first risk score, along with any and all received risk scores, at memory 115. For instance, server 101 may store received risk scores in database 121. Database 121 may store the risk scores and group them by categories (e.g., risk scores for a particular risk vector are grouped together, risk scores for a particular asset are grouped together, and the like). This may enable server 101 to quickly search through database 121 and analyze stored risk scores.

In certain aspects, after step 303, server 101 may compare the first risk score with other risk scores for the particular risk vector to determine the percentage of the other risk scores that are higher than the first risk score at step 305. Referring to the example provided above, server 101 may receive a system's compliance risk vector risk score of 170. In some aspects, server 101 may store the first risk score prior to performing the comparison at step 305. In some other aspects, server 101 may not store the first risk score prior to performing the comparison at step 305. Server 101 may receive the system's compliance risk vector risk score of 170 and compare the risk score with compliance risk vector risk scores of other systems stored at memory 115 (e.g., at database 121). For a large enterprise, the number of assets (e.g., systems) may be in the thousands or millions; but for exemplary purposes, server 101 may store compliance risk vector risk scores for 19 systems. Each of the system risk scores may range from 0-300. Therefore, server 101 may compare the received first score of 170 with compliance risk scores for the 19 stored systems to determine the percentage of the 19 stored risk scores that are higher than 170. For instance, server 101 may determine that 3 of the 19 compliance risk scores are higher than 170. In this example, the percentage of compliance risk scores that are higher than the received first score is 3 out 19. In other words, the first risk score (170) is the 4th highest compliance risk score of the 20 total risk scores stored at server 101. Thus, server 101 may determine that the first risk score is at the 20th percentile of highest compliance risk vectors (e.g., 4th highest out of 20 total equals 20th percentile).

In certain aspects, server 101 may perform a similar calculation for all risk scores across all risk vectors in an enterprise. Server 101 may perform the calculation when it receives a risk score, at some periodic intervals, or upon request. Server 101 may perform the calculation to determine the range of risk scores for a risk vector that fall within predefined percentiles. Staying with the compliance risk vector example, server 101 may determine the range of risk scores that fall then top 10% highest scores, the second 10% highest scores, the third 10% highest scores, the fourth 10% highest scores, and the bottom 60% lowest scores. The percentiles may be predefined by server 101 or another third-party (e.g., a bank employee). Server 101 may then analyze and compare all of the stored compliance risk scores to determine the range of scores that fall within the predefined percentiles (e.g., server 101 may determine that scores between 205-300 are in the highest 10%, scores between 164 and 204 are in the second 10% highest scores, risk scores between 144 and 163 are in the third 10% highest scores, scores between 126 and 143 are in the fourth 10% highest scores, and scores between 0 and 125 are in the bottom 60% lowest scores).

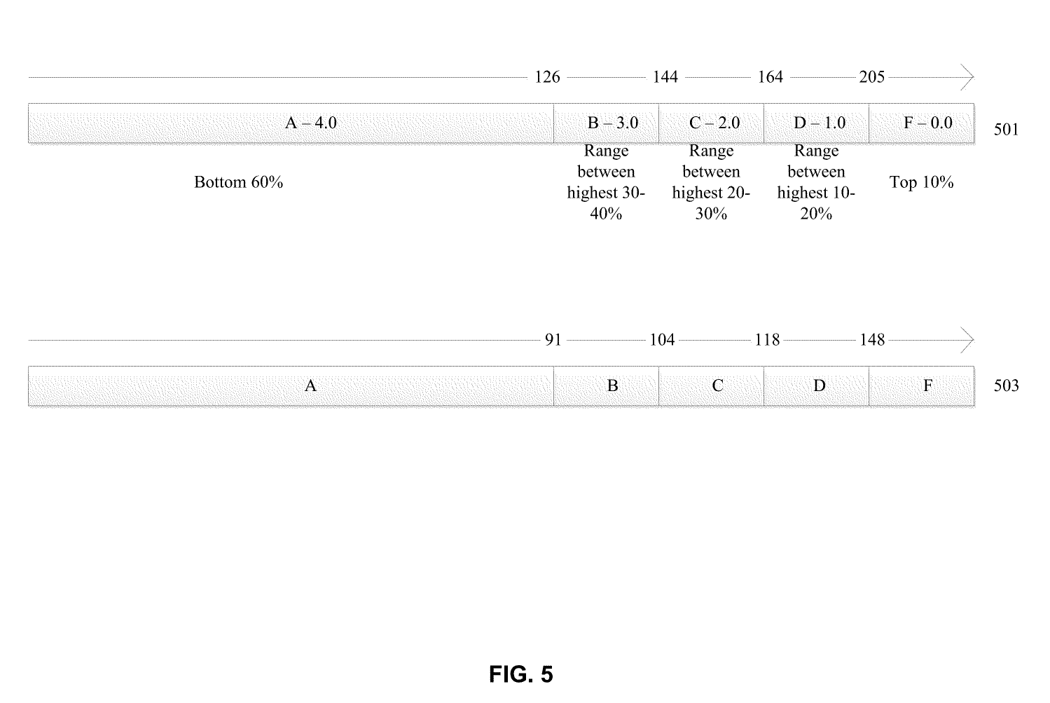

Server 101 may then calculate a grade for the first asset's level of risk for the first risk vector at step 307. In some aspects, server 101 may calculate the grade based on calculated percentages at step 305 and a grading rubric. The grading rubric may be stored at memory 115 and may provide server 101 a set of instructions for converting risk scores to grades. An exemplary portion of a grading rubric is shown in FIG. 5.

Server 101 may analyze a grading rubric such as grading rubric 501 to convert the first system's compliance risk score to a grade. As shown in grading rubric 501, the predefined percentiles from step 305 may each be associated with a grade. Also, each range of compliance risk scores may be associated with a respective grade. The grades may be letter grades similar to those applied in schooling (e.g., A, B, C, D, F). An “A” grade may be the highest, or best grade and an “F” grade may be the lowest, with the other grades falling between according to alphabetical order (e.g., B is better than C, and the like). In some aspects, the grades may include other performance indicators such as a “+” or a “−” (e.g., a B+ may be better than a B, and a B− may be worse than a B, and the like). Furthermore, each grade may be associated with a grade point, also similar to grade points applied in schooling. For example, as shown in grading rubric 501, an “A” may be the highest possible grade and may be associated with a 4.0 grade point, a “B” grade may be associated with a 3.0 grade point, and the like.

In certain aspects, the highest risk scores may receive the lowest grades by server 101. This is because higher risk scores indicate that an asset may be more harmful in the network than assets with lower risk scores. Thus, a lower risk score may often be preferable to a higher risk score. So assets with lower risk scores may merit a higher grade than assets with high risk scores. In this way, the grading rubric may serve to apply reverse grading (e.g., higher scores receive lower grades).

At step 307, server 101 may calculate the grade for the first asset's level of risk for the first risk vector by comparing the risk score to the grading rubric. For example, after server 101 receives a compliance risk score of 170, server 101 may compare the 170 risk score to grading rubric 501. In so doing, server 101 may recognize that compliance risk scores between 164 and 205 must be assigned a “D” grade. Therefore, at step 307, server 101 may calculate that the first system's compliance risk vector grade is a D and is associated with a 1.0 grade point.

In some aspects, server 101 may then proceed to step 309 and output the grade. Server 101 may output the grade via input/output module 109 to a third-party (e.g. a bank manager) or other assets in the enterprise. In some aspects, server 101 may not output the grade, but may instead store the grade at memory 115.

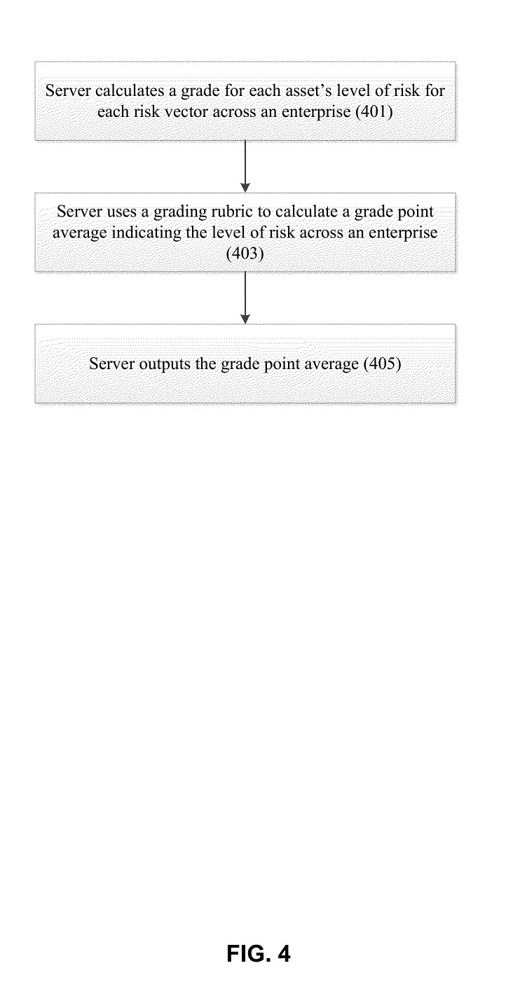

As shown in FIG. 4, server 101 may perform similar steps as those described in FIG. 3 to calculate a grade indicating each asset's level of risk for each risk vector across an enterprise. For example, each asset (e.g., system) may comprise various risk vectors (e.g., compliance, vulnerability, malware, and the like). Just as server 101 calculated a “D” grade for the first system's compliance vector, server 101 may calculate a grade for the system's malware vector. The malware risk scores may comprise a different scoring range than the compliance vector (e.g., 0-700 rather than 0-300). Server 101 may perform the steps described in FIG. 3 to calculate predefined percentiles of scores for the malware risk vector (e.g., determine the top 10% of highest malware risk scores, bottom 60%, and the like). Server 101 may provide a uniform scoring system for assets across the enterprise to ensure consistent grading. For instance, risk scores across all risk vectors in the highest 10% of the respective risk vector may be assigned an “F” grade in the grading rubric, the bottom 60% may be assigned an “A” grade, and the like. Thus, regardless of the inconsistent scoring systems applied for risk scoring across different risk vectors, server 101 may provide a uniform scoring system across all assets and across all risk vectors.

At step 403, server 101 may use the grading rubric to calculate a grade point average indicating the level of risk across the enterprise. Server 101 may calculate grade point averages by averaging the grade points associated with each asset's respective risk vector grades. For instance, systems in an enterprise may be associated with three risk vectors (e.g., vulnerability, compliance, and malware). A system in the enterprise, as an example, may receive grades of “D” for compliance, “A” for malware, and “A” for vulnerability. Server 101 may analyze a grading rubric (e.g., grading rubric 501) and recognize that the respective grade points for the system's three grades are 1.0, 4.0, and 4.0. Server 101 may, therefore, average the grade points to calculate a grade point average of 3.0. Thus, the overall level of security for that particular system is 3.0.

Server 101 may store the system's grade point average at memory 115. Similarly, server 101 may store other information about the asset, including its grade for each risk vector, the risk score for each risk vector, the list of vulnerabilities associated with each risk score, the date the grade was calculated, and the like. Each asset's information may be stored and associated together in memory 115.

Server 101 may perform similar calculations for each system in the enterprise and all other assets (e.g., users, applications, and the like) in the enterprise. Server 101 may, then, calculate grade point averages within asset groups. For example, an enterprise may comprise two systems. The first system may receive a grade point average of 3.0, and the second system may receive a grade point average of 2.0. Therefore, server 101 may calculate the grade point average for all systems in the enterprise to be 2.5 (e.g., averaging the first and second grade point averages). Server 101 may also calculate grade point averages across asset groups. For example, the total grade point average for systems in an enterprise may be 2.5 and the total grade point average for users in an enterprise may be 3.5. Accordingly, server 101 may calculate the grade point average across the entire enterprise is 3.0 (e.g., the average of all grade point averages for all assets in the enterprise). Memory 115 may store all of the grade point average information across the enterprise (e.g., at database 121).

In some aspects, server 101 may not receive risk scores for various risk scores. In such instances, server 101 may apply NULL logic to represent the missing risk scores. Thus, rather than assigning risk scores for the missing risk scores (e.g., 0.0) that may skew the grade point average calculations, the missing risk scores may be excluded from the grade point average calculations and subsequent aggregation.

Server 101 may aggregate risk grades at multiple levels, both vertically and horizontally. Horizontal aggregation may refer to the calculation and aggregation of risk grades according to risk vectors (e.g., compliance risk vector vs. malware risk vector, and the like). Vertical aggregation may refer to the calculation and aggregation of risk grades according to organizational risk (e.g., risk among various divisions of an enterprise). At step 405, server 101 may output the grade point average and/or risk grade for an entire enterprise. Server 101 may output the risk grade information via input/output module 109. In some aspects, the grade point average and grade may be output to a network administrator (e.g., bank manager). The bank manager may, for example receive from server 101 a report of the enterprise's security level (e.g., via charts, graphs, and the like). The bank manager may be able to view the bank enterprise's total risk grade (e.g., a “B” grade). The bank manager may be able to drill down vertically to see why the enterprise received a “B” grade and identify areas that need improvement. For example, may drill down by division and find that a certain division received a “D” grade. The bank manager may then drill down further to find a certain subdivision within the division received an “F” grade. The bank manager can continue drilling down vertically and view the various grades earned by assets and collections of assets in the enterprise. Similarly, the bank manager may prefer to analyze the risk grade horizontally by risk vectors. Server 101 may provide total grades for each risk vector in the enterprise. The network administrator may view risk grades by risk vector and then view the grades of assets associated with the risk vector.

In certain aspects, server 101 may convert risk grades or grade point averages to the original scores using the reverse of the process described in FIG. 3. Server 101 may receive a risk grade and compare the risk grade to the grading rubric to determine the risk score. In some other aspects, server 101 may convert risk grades to risk scores by retrieving the risk scores stored in memory 115.

In some aspects, the grading rubric (e.g., grading rubric 501) may remain static for a period of time. The period of time may be periodic (e.g., annual) or by request (e.g., from a network administrator). By keeping the grading rubric static for a period of time (e.g., annually), server 101 may maintain consistency in its risk grading. However, after the period of time, server 101 may recalibrate the grading rubric. Server 101, or a third party, may recalibrate the grading rubric by converting grade boundaries back to raw risk score ranges. For example, grading rubric 101 may remain static at server 101 for one year. Thus, all assets with compliance risk scores received during the static period that are 205 or higher may receive an “F” grade for the compliance risk vector. As the highest risks are mitigated, the risk scores associated with grading percentiles may change. So, although the highest 10% of scores at the beginning of the static period was 205 and higher, after one year, the highest 10% of scores may comprise a lower range of risk scores (e.g., 148 and higher). Server 101 may recalibrate the grading rubric (e.g., grading rubric 501) after the static period to reflect the changes to the risk score ranges (e.g., as shown in recalibrated grading rubric 503). Server 101 may then apply recalibrated grading rubric 501 to calculate risk grades until the next recalibration.

The foregoing descriptions of the disclosure have been presented for purposes of illustration and description. They are not exhaustive and do not limit the disclosure to the precise form disclosed. Modifications and variations are possible in light of the above teachings or may be acquired from practicing of the disclosure. For example, the described implementation includes software by the present disclosure may be implemented as a combination of hardware and software or in hardware alone. Additionally, although aspects of the present disclosure are described as being stored in memory, one skilled in the art will appreciate that these aspects can also be stored on other types of computer-readable media, such as secondary storage devices, like hard disks, floppy disks, or CD-ROM.

What is claimed is:

1. A computer-implemented method, comprising:
receiving, at a server a first risk score, wherein the first risk score indicates a first asset's level of risk for a particular risk vector;
storing the first risk score at the server;
comparing, at the server, the first risk score with other risk scores to determine a percentage of the other risk scores that are higher than the first risk score, wherein the other risk scores indicate other assets' level of risk for the particular risk vector;
calculating, at the server, a first grade for the first asset's level of risk for the particular risk vector, wherein the first grade is calculated based on the percentage and a predetermined grading rubric; and
outputting, at the server, the first grade.

2. The method of claim 1, further comprising:
receiving, at the server, a second risk score, wherein the second risk score indicates a second asset's level of risk for another risk vector;
storing the second risk score at the server;
comparing, at the server, the second risk score with risks scores that indicate other assets' level of risk for the another risk vector to determine a second percentage of risk scores that indicate other assets' level of risk for the another risk vector that are higher than the second risk score;
calculating, at the server, a second grade for the second asset's level of risk for the particular risk vector, wherein the second grade is calculated based on the second percentage and the predetermined grading rubric.

3. The method of claim 2, wherein the first grade is associated with a first grade point and the second grade is associated with a second grade point.

4. The method of claim 3, further comprising generating, at the server, a grade point average indicating the level of risk for the first asset and the second asset, wherein the grade point average is generated by calculating the average of the first grade point and the second grade point.

5. The method of claim 1, wherein the grade is NULL if the server does not receive a risk score.

6. The method of claim 1, wherein the grade is either A, B, C, D, F, or NULL.

7. The method of claim 1, further comprising storing, at the server, a list of vulnerabilities that produced the first risk score.

8. The method of claim 1, further comprising periodically recalibrating, at the server, the grading rubric.

9. The method of claim 1, wherein the grading rubric assigns a first highest percentage an F grade, a second highest percentage a D grade, a third highest percentage a C grade, a fourth highest percentage a B grade, and a lowest percentage an A grade, wherein the lowest percentage consists of risk scores lower than those in any other percentage and the first highest percentage consists of risk scores higher than those in any other percentage.

10. A non-transitory computer-readable storage medium having computer-executable program instructions stored thereon that, when executed by a processor, cause the processor to:
receive, at a server, a plurality of risk scores for a plurality of assets in an enterprise, wherein each asset is associated with each risk score indicating the asset's level for a particular risk vector;
for each risk vector, comparing, at the server, each risk score to determine a percentage of the plurality of risk scores that are higher than each risk score;
calculating, at the server, a grade for the each asset's level of risk for the particular risk vector, wherein the first grade is calculated based on the percentage and a predetermined grading rubric; and
outputting, at the server, the grade.

11. The non-transitory computer-readable storage medium of claim 10, wherein each grade is associated with a grade point.

12. The transitory computer-readable storage medium of claim 11, wherein the instructions stored thereon further cause the processor to generate, at the server, a grade point average indicating the level of risk for each asset, wherein the grade point average is generated by calculating the average of the grade points.

13. The transitory computer-readable storage medium of claim 10, wherein the grading rubric assigns a first highest percentage an F grade, a second highest percentage a D grade, a third highest percentage a C grade, a fourth highest percentage a B grade, and a lowest percentage an A grade, wherein the lowest percentage consists of risk scores lower than those in any other percentage and the first highest percentage consists of risk scores higher than those in any other percentage.

14. The transitory computer-readable storage medium of claim 11, wherein the instructions stored thereon further cause the processor to periodically recalibrate, at the server, the grading rubric.

15. An apparatus comprising:
a memory;
a processor, wherein the processor executes computer-executable program instructions which cause the processor to:
receive a plurality of risk scores for a plurality of assets in an enterprise, wherein each asset is associated with each risk score indicating the asset's level for a particular risk vector;
for each risk vector, compare each risk score to determine a percentage of the plurality of risk scores that are higher than each risk score;
calculate a grade for the each asset's level of risk for the particular risk vector, wherein the first grade is calculated based on the percentage and a predetermined grading rubric; and
output the grade.

16. The apparatus of claim 15, wherein each grade is associated with a grade point.

17. The apparatus of claim 16, wherein the computer-executable program instructions further cause the processor to generate a grade point average indicating the level of risk for each asset, wherein the grade point average is generated by calculating the average of the grade points.

18. The apparatus of claim 15, wherein the grading rubric assigns a first highest percentage an F grade, a second highest percentage a D grade, a third highest percentage a C grade, a fourth highest percentage a B grade, and a lowest percentage an A grade, wherein the lowest percentage consists of risk scores lower than those in any other percentage and the first highest percentage consists of risk scores higher than those in any other percentage.

19. The apparatus of claim 15, wherein the computer-executable program instructions further cause the processor to periodically recalibrate, at the server, the grading rubric.

20. The apparatus of claim 15, wherein the computer-executable program instructions further cause the processor to store a list of vulnerabilities that produced the first risk score.
